(19) United States
(12) Patent Application Publication
(10) Pub. No.: US 2008/0133656 A1
(43) Pub. Date: Jun. 5, 2008

(54) Reproducer and content reproduction method

(75) Inventor: Hiroyuki Hashimoto, Suwa-gun (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/987,495

(22) Filed: Nov. 30, 2007

(30) Foreign Application Priority Data
Dec. 5, 2006 (JP) 2006-327775

(51) Int. Cl. G06F 15/16

(52) U.S. Cl. 709/203

(57) ABSTRACT

In a content reproduction system, a first reproducer receives content information sent from a content server to the first reproducer via a network by unicast communication and reproduces first content information included in the received content information. A second reproducer captures the content information transmitted on the network from the content server in a promiscuous mode, acquires control information required for reproduction of second content information, which is included in the captured content information and is to be reproduced with the first content information at a synchronized timing, from the content server via the network, and reproduces the second content information based on the acquired control information. This arrangement enables synchronization of the reproduction timing of the first content information with the reproduction timing of the second content information without multicast communication.

### BACKGROUND OF THE INVENTION

1. Field of the Invention

The present invention relates to a technique applied to a content reproduction system using a first reproducer and a second reproducer to respectively reproduce first content information and second content information, which constitute one set of content information and are to be reproduced at a synchronized timing, for example, video information and audio information relevant to the video information. The technique of the present invention enables synchronization of a reproduction timing of the first content information by the first reproducer with a reproduction timing of the second content information by the second reproducer.

2. Description of the Related Art

Video information and audio information, which are to be reproduced at a synchronized timing, may be reproduced by different reproducers. A known configuration for attaining simultaneous reproduction of the video information and the audio information in conformity with the standard of RFC1889 adopts RTP (Realtime Transport Protocol)-based multicast communication and RTCP (RTP Control Protocol)-based active feedback control to adjust a reproduction timing of video stream data representing the video information and a reproduction timing of audio stream data representing the audio information.

In this prior art configuration, however, the specification of the RTP does not allow operation control between different clients, that is, operation control from an image reproducer to a sound reproducer or operation control from the sound reproducer to the image reproducer. Even if the user suspends the operation of the image reproducer, the operation of the sound reproducer can not be suspended synchronously. The multicast communication requires a high network band for transmission of information from a server to a reproducer and accordingly has a high potential for occupation of the network.

A relevant technique has been disclosed, for example, in Japanese Patent Laid-Open No. H07-23341.

In reproduction of first content information and second content information, which constitute one set of content information and are to be reproduced at a synchronized timing, respectively by a first reproducer and a second reproducer, there would be a demand for a technique of enabling synchronization of a reproduction timing of the first content information with a reproduction timing of the second content information without multicast communication.

### SUMMARY OF THE INVENTION

In order to achieve at least part of the above demands, one aspect of the invention pertains to a content reproduction system including a content server, a first reproducer, and a second reproducer that are mutually connected via a network. The first reproducer reproduces first content information in one set of content information, which includes the first content information and second content information to be reproduced at a synchronized timing, while the second reproducer reproduces the second content information. The first reproducer receives the content information sent from the content server to the first reproducer via the network by unicast communication, and reproduces the first content information included in the received content information. The second reproducer captures the content information transmitted on the network from the content server in a promiscuous mode, acquires control information required for reproduction of the second content information, which is included in the captured content information, from the content server via the network, and reproduces the second content information based on the acquired control information.

In the content reproduction system, the first reproducer and the second reproducer respectively reproduce the first content information and the second content information, which constitute one set of content information and are to be reproduced at a synchronized timing. The content reproduction system according to this aspect of the invention enables synchronization of the reproduction timing of the first content information with the reproduction timing of the second content information without multicast communication.

In one preferable application of the content reproduction system according to the above aspect of the invention, the second reproducer captures the content information sent from the content server to the first reproducer by unicast communication from all the content information transmitted on the network and captured in the promiscuous mode, analyzes the captured content information sent to the first reproducer to acquire sender identification information of the captured content information, and acquires the control information from the content server based on the acquired sender identification information.

In another preferable application of the content reproduction system according to the above aspect of the invention, the second reproducer acquires both the control information and content-related information and reproduces the second content information based on the acquired control information while displaying the acquired content-related information.

The invention is not restricted to the content reproduction system described above, but the technique of the invention may also be actualized by diversity of other applications, for example, a corresponding content reproduction method and a reproducer used in the content reproduction system. Other possible applications of the invention include a computer program for actualizing the content reproduction system or the content reproduction method, a recording medium in which such a computer program is recorded, and a data signal that includes such a computer program and is embodied in a carrier wave.

In the applications of the invention as the computer program and the recording medium in which the computer program is recorded, the invention may be given as a whole program to control the operations of the content reproduction system or as a partial program to exert only the characteristic functions of the invention. Available examples of the recording medium include flexible disks, CD-ROMs, DVD-ROMs and DVD-RAMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 is a functional block diagram showing the configuration of a video reproduction system as one embodiment of a content reproduction system of the invention; and

FIG. 2 is a flowchart showing a procedure of sound reproduction in a sound reproducer.

### DESCRIPTION OF THE PREFERRED EMBODIMENTS

Some modes of carrying out the invention are described below in the following sequence with reference to the accompanied drawings:

### A. Embodiment

A1. Configuration of Video Reproduction System
A2. Operations of Sound Reproducer
A3. Effects

### B. Modifications

### A. EMBODIMENT

### A1. CONFIGURATION OF VIDEO REPRODUCTION SYSTEM

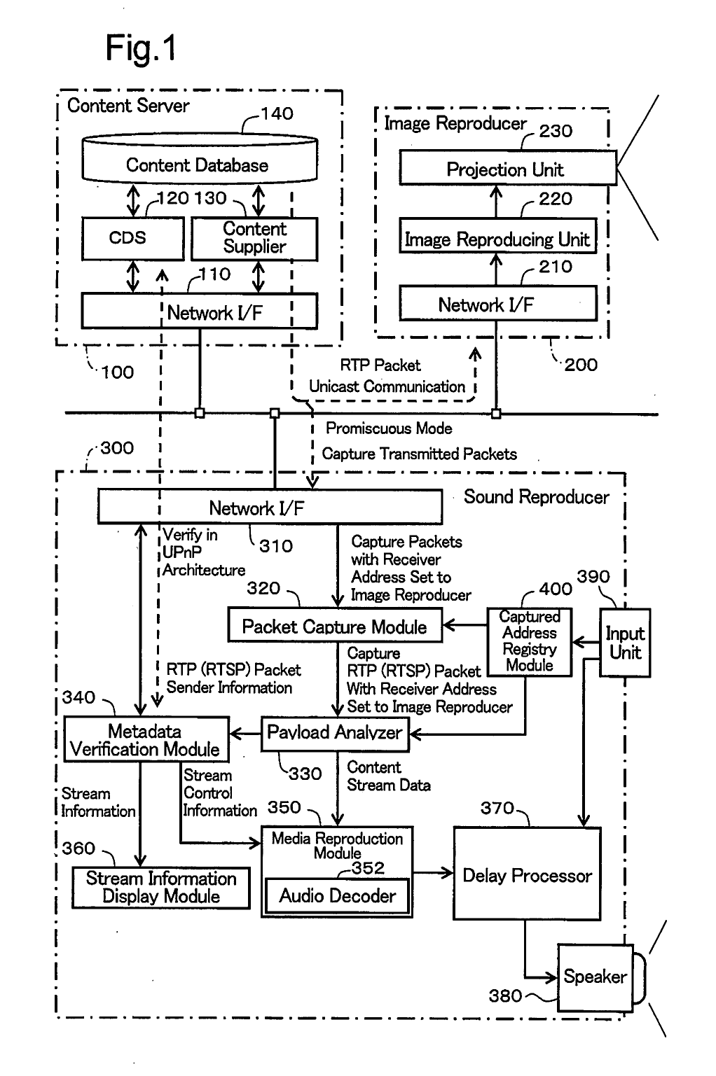

FIG. 1 is a functional block diagram showing the configuration of a video reproduction system as one embodiment of a content reproduction system of the invention. The video reproduction system includes a content server 100 and an image reproducer 200 and a sound reproducer 300 that are connected to the content server 100 via a network NW. The network NW may be a wired network, such as IEEE802.3i/802.3u (Ethernet (registered trademark)) or a wireless network, such as IEEE802.11a/b/g.

The content server 100 is constructed as a computer system (not shown) including a CPU, internal memories like a ROM and a RAM, external storage devices like a hard disk drive, and a network communication unit. The content server 100 executes various computer programs to attain functional blocks shown in FIG. 1.

In the content server 100, a network interface (network I/F) 110 performs communications according to diverse communication protocols via the network NW.

A content supplier 130 reads out content data, which is to be reproduced by the image reproducer 200 and the sound reproducer 300, from a content database 140 and sends the read-out content data as a UDP (Universal Datagram Protocol)-relevant RTP-based packet including content stream data (hereafter simply referred to as ‘RTP packet’) to the image reproducer 200 via the network I/F 110 by unicast communication.

A content directory service (CDS) module 120 works as a content management mechanism to attain the content directory service (CDS) defined by UPnP (Universal Plug and Play) device architecture version 1.0 and manage the contents registered in the content database 140. The CDS module 120 correlates a content file name of each content under management to content relevant information and stores the correlated content relevant information in a content registry list (not shown). The content relevant information of each content includes location information representing a storage location of the content expressed by a URL (uniform resource locator), content detail information including the name and the size of the content, and content attribute information. The CDS module 120 utilizes this content registry list for management of the contents. At least part of the managed content relevant information is provided as stream information described later.

As described later, the CDS module 120 responds to UPnP-based inquiries and instructions given by a metadata verification module 340 of the sound reproducer 300 via the network I/F 110 and sends information on the details of the content stream data sent from the content supplier 130 to the image reproducer 200 (hereafter referred to as ‘stream information’) and control information required for reproduction of the content stream data (hereafter referred to as ‘stream control information’) to the sound reproducer 300.

The image reproducer 200 may be constructed by any of general image display devices connectable with a network, for example, a projector, a direct-view liquid crystal display, or a plasma display. In the video reproduction system of this embodiment, a projector is adopted for the image reproducer 200. The image reproducer 200 is constructed as a computer system (not shown) including a CPU, internal memories like a ROM and a RAM, and a network communication unit. The image reproducer 200 executes various computer programs to attain functional blocks shown in FIG. 1.

In the image reproducer 200, a network I/F 210 performs communications according to diverse communication protocols via the network NW. More specifically the network I/F 210 receives an RTP packet sent from the content server 100 to the image reproducer 200 by unicast communication and transmits content stream data included in the received RTP packet to an image reproducing unit 220.

The image reproducing unit 220 reproduces video stream data included in the content stream data transmitted from the network I/F 210. The reproduced video stream data is projected and displayed by a projection unit 230.

The content stream data is provided in any of various formats, such as MPEG-TS, MPEG-PS, and Windows Media Video. The image reproducing unit 220 performs a reproduction process according to the format of the content stream data.

The reproduction of an image in the image reproducer 200 follows the known series of operations and is thus not specifically described here.

The sound reproducer 300 is a speaker system connected to the network NW. The sound reproducer 300 is also constructed as a computer system (not shown) including a CPU, internal memories like a ROM and a RAM, and a network communication unit. The sound reproducer 300 executes various computer programs to attain functional blocks shown in FIG. 1. These functional blocks are described below in relation to the operations of the sound reproducer.

### A2. OPERATIONS OF SOUND REPRODUCER

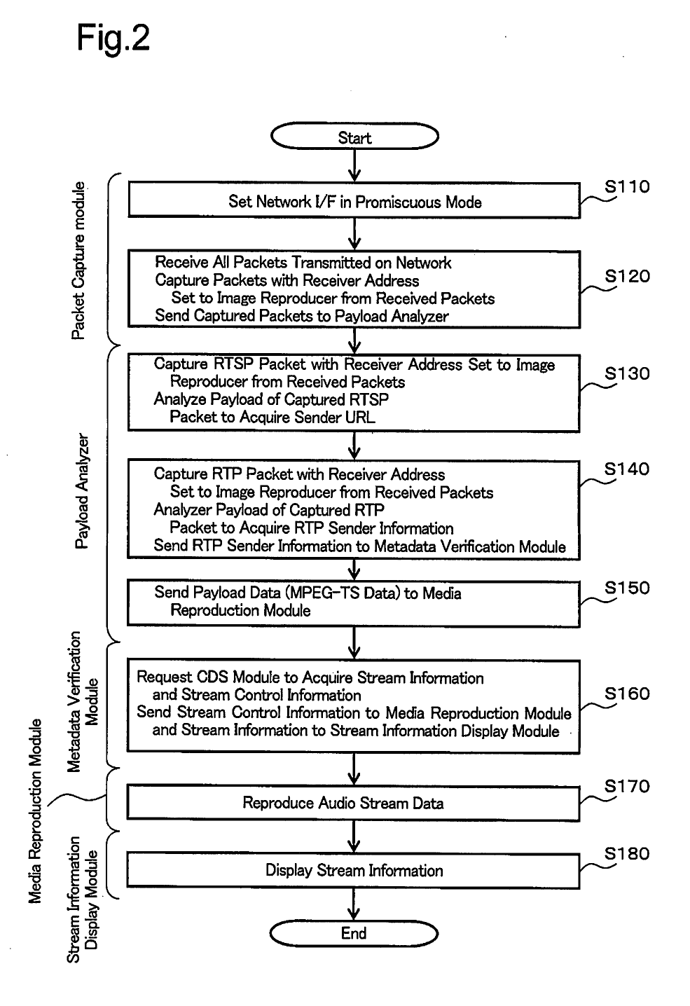

FIG. 2 is a flowchart showing a procedure of sound reproduction in the sound reproducer 300. On a start of sound reproduction, the respective functional blocks of the sound reproducer 300 perform the operations according to this procedure.

At step S110, a packet capture module 320 sets an operation mode of a network I/F 310 in a promiscuous mode. The network I/F 310 set in the promiscuous mode captures all packets transmitted on the network NW and sends the captured packets to the packet capture module 320. The network I/F 310 continues this operation until cancellation of the setting in the promiscuous mode.

At step S120, the packet capture module 320 captures packets having a receiver address set to the image reproducer 200 from all the packets sent from the network I/F 310, and sends the captured packets to a payload analyzer 330. The packet capture module 320 continues this operation until input of an operation stop instruction.

The receiver address is registered in advance into a captured address registry module 400 by the user's operation of a keyboard or another input unit 390. The registered receiver address is transmitted from the captured address registry module 400 to the packet capture module 320 and the payload analyzer 330. The receiver address is defined by identification information of the image reproducer 200, for example, an IP address or an MAC address.

At step S130, the payload analyzer 330 captures an RTSP (Realtime Streaming Protocol)-based packet (hereafter referred to as ‘RTSP packet’) from the packets with the receiver address set to the image reproducer 200 sent from the packet capture module 320, and analyzes the payload of the captured RTSP packet to acquire a sender URL of an RTP packet, which is sent to the image reproducer 200.

At step S140, the payload analyzer 330 also captures an RTP packet from the packets with the receiver address set to the image reproducer 200 sent from the packet capture module 320, analyzes the payload of the captured RTP packet to acquire required data including a payload type and a sender address, and sends the acquired sender address and the sender URL as RTP sender information to the metadata verification module 340.

The locations of the payload type, the sender address, and the other required pieces of data in the RTP packet are standardized by RFC2250 and are not specifically described here.

At step S150, the payload analyzer 330 extracts content stream data corresponding to the analyzed payload type from the payload data and sends the extracted content stream data to a media reproduction module 350.

At step S160, the metadata verification module 340 receiving the RTP sender information acquires the stream control information that is required for reproduction of audio stream data included in the content stream data sent from the payload analyzer 330 to the media reproduction module 350 and the stream information that represents the details of the content stream data, and sends the acquired stream control information to the media reproduction module 350 and the acquired stream information to a stream information display module 360. The stream control information includes, for example, a data format of the audio stream data, a sampling rate, and an emphasis setting. The stream information includes, for example, an audio information name, a reproduction time, and a data format.

The metadata verification module 340 acquires the stream control information and the stream information according to the following procedure. The metadata verification module 340 first makes an inquiry about the acquired sender URL to the CDS module at the sender address of the RTP packet sent from the payload analyzer 330 (in the illustrated example, the CDS module 120 of the content server 100), verifies whether a sender URL corresponding to the object content stream data to be reproduced is present at the sender address of the RTP packet, and specifies the verified sender URL. The metadata verification module 340 then acquires the stream control information and the stream information corresponding to the object content stream data to be reproduced from the specified sender URL. Various UPnP-based commands are used for the access from the metadata verification module 340 via the network I/F 310 to the CDS module 120 of the content server 100.

At step S170, the media reproduction module 350 receiving the content stream data and the stream control information controls an audio decoder 352 to reproduce audio stream data included in the received content stream data based on the received stream control information and outputs the reproduced audio stream data as audio output from a speaker 380.

The audio output from the speaker 380 may be delayed by a preset delay amount (delay time) by a delay processor 370 according to the requirements. In general, video stream data reproduced by the image reproducer requires a longer time for reproduction than audio stream data reproduced by the sound reproducer. The delay of the audio output thus aims to synchronize the reproduction timing of the audio stream data with the reproduction timing of the video stream data. The delay amount may be set in advance by the user's specification through the operation of the input unit 390. This delay process of the audio output may be omitted when the video reproduction circuit has an extremely high performance and allows the high-speed processing.

The stream information display module 360 includes a display device, for example, a liquid crystal display. At step S180, the stream information display module 360 displays the received stream information on the display device. This enables the user to visually check the stream information of the currently reproduced stream.

According to the series of processing described above, the sound reproducer 300 captures the content stream data sent from the content server 100 to the image reproducer 200 and reproduces the audio stream data included in the captured content stream data.

### A3. EFFECTS

In the video reproduction system of the embodiment, the sound reproducer 300 captures the content stream data sent from the content server 100 to the image reproducer 200. Synchronously with transmission of the content stream data to the image reproducer 200 and subsequent reproduction of the video stream data included in the received content stream data by the image reproducer 200, the sound reproducer 300 reproduces the audio stream data included in the captured content stream data. Synchronously with stop of transmission of the content stream data to the image reproducer 200 and resulting stop of reproduction of the video stream data by the image reproducer 200, the sound reproducer 300 stops reproduction of the audio stream data. Synchronously with various control operations, such as a rewiring operation or a fast-forward operation, in the image reproducer 200, the sound reproducer 300 performs the corresponding control operations. Namely in synchronism with various reproduction control operations including reproduction, stop, rewind, fast-forward, and pause operations in the image reproducer 200, the sound reproducer 300 performs the corresponding reproduction control operations. The video reproduction system of the embodiment does not require independent control of the reproduction control operations in the image reproducer 200 and in the sound reproducer 300, thus ensuring easy and accurate reproduction control.

The video reproduction system of the embodiment is constructed by adding the sound reproducer 300 connecting with the network NW to the conventional basic video reproduction system including the content server 100 and the image reproducer 200 interconnected via the network NW. Such construction does not damage or sacrifice any configuration or any functions of the basic video reproduction system. For example, in the configuration of the image reproducer having the sound reproducing function, the image reproducer may reproduce both the video stream data and the audio stream data included in the content stream data sent from the content server. The user may alternatively select the reproduction source of the audio stream data between the image reproducer and the sound reproducer.

In the video reproduction system of the embodiment, the stream information display module 360 of the sound reproducer 300 is able to display the stream information of the currently reproduced stream. This arrangement enables the user to readily check the stream information of the currently reproduced stream without any interference with the image viewing, compared with overlay display of the stream information over the image reproduced by the image reproducer 200.

As clearly understood from the above description, the video information represented by the video stream data corresponds to the first content information of the invention, and the audio information represented by the audio stream data corresponds to the second content information of the invention. The image reproducer and the sound reproducer are respectively equivalent to the first reproducer and the second reproducer of the invention.

### B. MODIFICATIONS

The embodiment discussed above is to be considered in all aspects as illustrative and not restrictive. There may be many modifications, changes, and alterations without departing from the scope or spirit of the main characteristics of the present invention.

### B1. MODIFIED EXAMPLE 1

In the video reproduction system of the embodiment, the sound reproducer captures the content stream data sent to the image reproducer by unicast communication. This is, however, not restrictive but the technique of the invention may also be actualized by the opposite configuration.

### B2. MODIFIED EXAMPLE 2

In the video reproduction system of the embodiment, the metadata verification module acquires the stream control information and the stream information from the CDS module of the content server. This configuration is, however, not restrictive, but the user may operate the input unit to selectively enter the stream control information and the stream information among the selectable pieces of information or may operate the input unit to directly input the stream control information and the stream information. Another modified configuration uses a separate file system. The stream control information and the stream information may be selected from the information stored in advance in the file system.

### B3. MODIFIED EXAMPLE 3

In the video reproduction system of the embodiment, the protocol RTP is used for transmission of content stream data sent from the content server to the image reproducer by unicast communication. This is, however, not essential, but the protocol HTTP (HyperText Transfer Protocol) may be adopted for the same purpose. In application of the HTTP protocol, an HTTP header is desirably designed in a format to have information for identifying the type of data transmitted by an HTTP body.

### B4. MODIFIED EXAMPLE 4

In the video reproduction system of the embodiment, the UPnP architecture is used for the access to the CDS module. This is, however, not essential but an SQL (Structured Query Language) database or an FAT (File Allocation Tables) file system may be adopted for the same purpose. Other applicable protocols include an IFO format generally used for DVDs and XML (Extensible Markup Language) protocols including RSS (Rich Site Summary) and Atom.

### B5. MODIFIED EXAMPLE 5

The sound reproducer may have additional means for selectively reproducing an audio stream included in a content stream. For example, the sound reproducer may have a switchover function between main audio and sub-audio.

### B6. MODIFIED EXAMPLE 6

The sound reproducer may reproduce and display caption information included in the content stream data on the stream information display module, in synchronism with the image reproduction.

### B7. MODIFIED EXAMPLE 7

The sound reproducer may reproduce an audio stream as BGM in synchronism with the image reproduction. For this purpose, the sound reproducer may have additional means for selectively specifying a desired audio stream among audio information stored in the content server.

### B8. MODIFIED EXAMPLE 8

The embodiment regards the video information and the audio information as the first content information and the second content information to be reproduced at the synchronized timing. This is, however, not essential, but the first content information and the second content information may be both video information or may be both audio information. The technique of the invention is applicable to reproduction of first content information and second content information, which constitute one set of content information and are to be reproduced at a synchronized timing, respectively by a first reproducer and a second reproducer.

What is claimed is:

1. In a content reproduction system comprising a content server, a first reproducer, and a second reproducer that are mutually connected via a network, where the first reproducer reproduces first content information in one set of content information, which includes the first content information and second content information to be reproduced at a synchronized timing, and the second reproducer reproduces the second content information, a reproducer used as the second reproducer,
the reproducer capturing the content information sent from the content server to the first reproducer via the network by unicast communication in a promiscuous mode, acquiring control information required for reproduction of the second content information, which is included in the captured content information and is to be reproduced with the first content information at the synchronized timing, from the content server via the network, and reproducing the second content information based on the acquired control information.

2. The reproducer in accordance with claim 1, wherein the reproducer captures the content information sent from the content server to the first reproducer by unicast communication from all the content information transmitted on the network and captured in the promiscuous mode, analyzes the captured content information sent to the first reproducer to acquire sender identification information of the captured content information, and acquires the control information from the content server based on the acquired sender identification information.

3. The reproducer in accordance with claim 1, wherein the reproducer acquires both the control information and content-related information and reproduces the second content information based on the acquired control information while displaying the acquired content-related information.

4. The reproducer in accordance with claim 2, wherein the reproducer acquires both the control information and content-related information and reproduces the second content information based on the acquired control information while displaying the acquired content-related information.

5. A content reproduction method in a content reproduction system including a content server, a first reproducer, and a second reproducer that are mutually connected via a network, where the second reproducer reproduces second content information in one set of content information, which includes first content information and the second content information to be reproduced at a synchronized timing,
the content reproduction method comprising the steps of
(a) causing the second reproducer to capture the content information sent from the content server to the first reproducer via the network by unicast communication in a promiscuous mode;
(b) causing the second reproducer to acquire control information required for reproduction of the second content information, which is included in the captured content information and is to be reproduced with the first content information at the synchronized timing, from the content server via the network; and
(c) causing the second reproducer to reproduce the second content information based on the acquired control information.

6. A computer program product adopted in a content reproduction system including a content server, a first reproducer, and a second reproducer that are mutually connected via a network,
the computer program product being executed to cause the second reproducer to reproduce second content information in one set of content information, which includes first content information and the second content information to be reproduced at a synchronized timing,
the computer program product comprising:
a first program code of capturing the content information sent from the content server to the first reproducer via the network by unicast communication in a promiscuous mode;
a second program code of acquiring control information required for reproduction of the second content information, which is included in the captured content information and is to be reproduced with the first content information at the synchronized timing, from the content server via the network;
a third program code of reproducing the second content information based on the acquired control information; and
a computer-readable medium to store the first to the third program codes therein.
